(19) United States
(12) Patent Application Publication
(10) Pub. No.: US 2001/0037502 A1
(43) Pub. Date: Nov. 1, 2001

(54) Digital broadcast receiver

(76) Inventors: Kazuhiro Kamemoto, Fukaya-shi (JP); Masanori Mori, Osato-gun (JP); Masaki Nakamura, Kumagaya-shi (JP)

Correspondence Address: Cushman Darby & Cushman Intellectual, Property Group of Pillsbury Madison & Sutro, LLP, East Tower, Ninth Floor, 1100 New York Avenue N.W., Washington, DC, 20005-3918, US

(21) Appl. No.: 09/863,515

(22) Filed: May 24, 2001

Related U.S. Application Data
(63) Continuation-in-part of application No. PCT/JP00/07022, filed on Oct. 10, 2000.

(30) Foreign Application Priority Data
Oct. 8, 1999 (JP) 11-288498

(51) Int. Cl. H04N 5/445; G06F 3/00

(52) U.S. Cl. 725/55

(57) ABSTRACT

In a digital broadcast receiver that reproduces received digital broadcast data on the basis of contract information recorded on an IC card, a semiconductor memory is built into the IC card and program selecting data contained in the digital broadcast data is written into the semiconductor memory.

### CROSS-REFERENCE TO RELATED APPLICATIONS

This is a Continuation Application of PCT Application No. PCT/JP00/07022, filed Oct. 10, 2000, which was not published under PCT Article 21(2) in English.

This application is based upon and claims the benefit of priority from the prior Japanese Patent Application No. 11-288498, filed Oct. 8, 1999, the entire contents of which are incorporated herein by reference.

### BACKGROUND OF THE INVENTION

The present invention relates to improvements in a digital broadcast receiver for use with digital broadcast services in which, for example, conditional access systems are adopted.

As is well known, for example, digital broadcast services which broadcast television programs in a digital form adopt a conditional access system that allows only viewers who have made a regular receiving contract at a predetermined cost to view the programs legally.

With the conditional access system, program providers scramble video signals and audio signals that make up television programs before transmission and supply viewers who have made the regular receiving contract with an IC (Integrated Circuit) card stored with contract information and descramble key information used to convert scrambled signals back into their original form.

The received video and audio signals can be descrambled by the viewers supplied with the IC card loading it into their own digital broadcast receivers, allowing the television programs to be viewed properly.

In fact, however, the conventional digital broadcast receivers for use with digital broadcast services in which such a conditional access system is adopted are still in the process of development; there is much room for improvement in many respects in order to meet satisfactorily the needs of viewers and to become more practical.

At present, as disclosed in, for example, Japanese Unexamined Patent Publication No. 10-271359, a technique is proposed which makes it easy to make a selection among programs by making a remote controller for a digital broadcast receiver into an interactive type and allowing information transfer between the remote controller and the broadcast receiver. So far, however, in this proposal as well no improvement has been made up to a sufficiently practical level.

It is therefore an object of the present invention to provide a very good digital broadcast receiver which is simple in construction which becomes well suited for practical use for viewers by making organic improvements on an IC card and its associated control system.

### BRIEF SUMMARY OF THE INVENTION

A digital broadcast receiver of the present invention is directed to one that receives digital broadcast data and includes control section for reproduce the digital broadcast data on the basis of contract information recorded on a memory card plugged into a card slot.

A memory for data storage is built into the memory card, and an interface section is added to the control section to obtain program selecting data contained in received digital broadcast data and write the received digital broadcast data into the memory in the memory card plugged into the card slot.

According to such a construction as described above, since the data storage memory is built into the memory card recorded with contract information and program selecting data contained in received digital broadcast data into the memory in the memory card plugged into the card slot, expansion of the receiver's function can be effected with simple arrangement and the receiver can be well suited for practical use for viewers.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 illustrates a first embodiment of a digital broadcast receiver according to the present invention and is a perspective view of a television broadcast receiver;

FIG. 2 is a block diagram of the signal processing system of the television broadcast receiver in the first embodiment;

FIG. 3 is a flowchart illustrating a first example of an operation in the first embodiment;

FIG. 4 is a flowchart illustrating a second example of an operation in the first embodiment;

FIG. 5 is a flowchart illustrating a third example of an operation in the first embodiment;

FIG. 6 is a flowchart illustrating a fourth example of an operation in the first embodiment;

FIG. 7 illustrates a second embodiment of the digital broadcast receiver according to the present invention and is a perspective view of a digital set-top box;

FIG. 8 is a flowchart illustrating one example of an operation in the second embodiment; and

FIG. 9 is a perspective view of a portable terminal in the second embodiment.

### DETAILED DESCRIPTION OF THE INVENTION

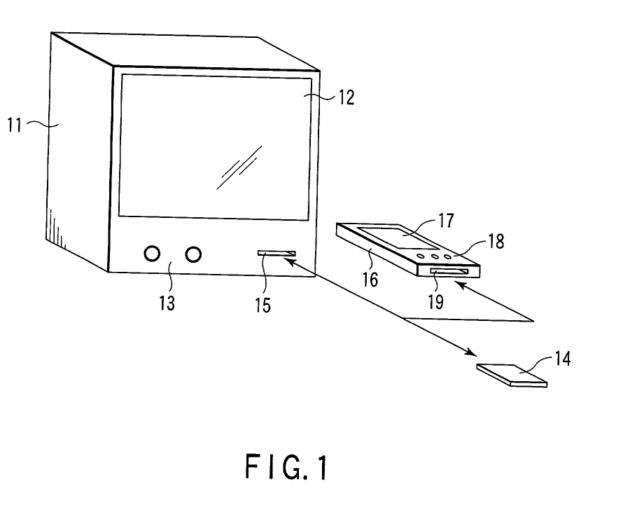

Hereinafter, a first embodiment of the present invention will be described in detail with reference to the drawings. First, FIG. 1 illustrates the exterior of a television broadcast receiver 11 which will be described as the first embodiment. That is, the television broadcast receiver 11 is equipped with a screen display unit 12 consisting of, for example, a CRT (Cathode Ray Tube) and various operating members 13 and with a card slot 15 into or from which a memory card (IC card) 14 is plugged or unplugged.

In this case, not only is the IC card 14 recorded with contract information and descramble key information as described previously, it also has a memory (semiconductor memory) built in for data storage. The IC card 14, in a state where it is plugged into the card slot 15, is allowed to transmit and receive data to and from the television broadcast receiver 11.

In addition, the television broadcast receiver 11 is equipped with a wireless remote controller 16 for remote control by a viewer. The remote controller 16 is equipped with a liquid crystal display unit 17 and various operating members 18 and has a card slot 19 into or from which the IC card 14 is plugged or unplugged. Naturally, the IC card 14, when plugged into the card slot 19, is allowed to transmit and receive data to and from the remote controller 16.

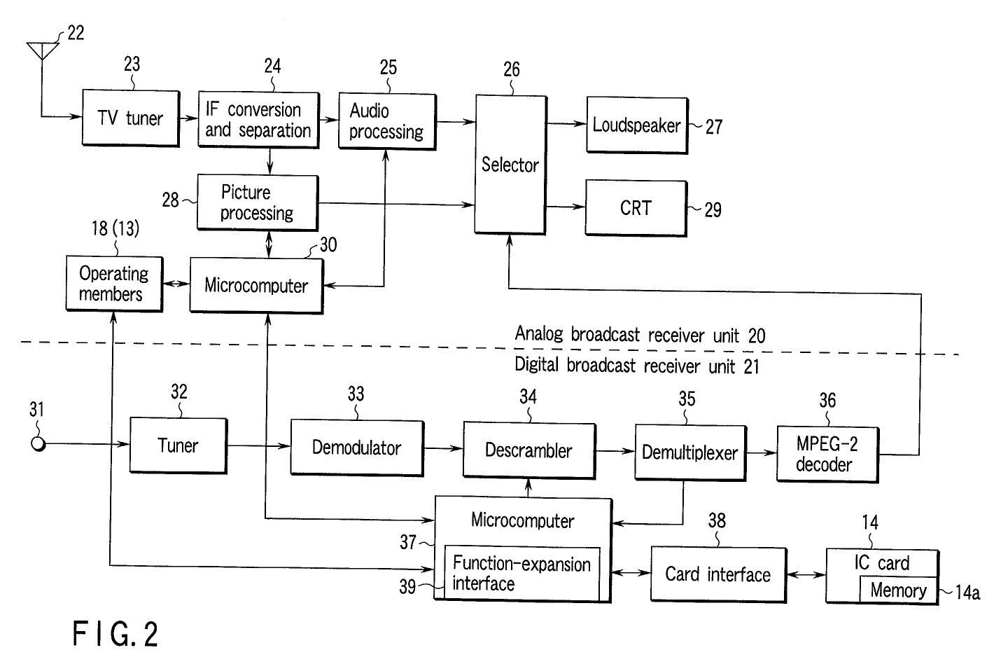

FIG. 2 illustrates the arrangement of the signal processing system in the television broadcast receiver 11. The signal processing system in the television broadcast receiver 11 is roughly divided into two systems: an analog broadcast receiver unit 20 which receives analog television broadcasts and performs signal processing on them, and a digital broadcast receiver unit 21 which receives digital television broadcasts and performs signal processing on them.

Of the two systems, the analog broadcast receiver unit 20 supplies analog television broadcast electromagnetic waves received by an antenna 22 to a TV (television) tuner 23 to extract a television signal on a desired channel. The television signal extracted in the TV tuner 23 is applied to an IF (Intermediate Frequency) conversion and separation unit 24 where it is converted into an intermediate frequency signal and then separated into an audio signal and a picture signal.

The audio signal separated in the IF conversion and separation unit 24 is applied to audio processing unit 25 where it is subjected to required processes, such as demodulation, etc., and then delivered through a selector 26 to a loudspeaker 27, whereby audio is reproduced. On the other hand, the picture signal separated in the IF conversion and separation unit 24 is applied to a picture processing unit 28 where it is subjected to required demodulation processing and so on and then conducted through the selector to a CRT 29, whereby a picture is displayed in the screen display unit 12.

The analog broadcast receiver unit 20 can receive and reproduce analog television broadcasts as a result of an analog television broadcast receiving microcomputer 30 controlling each unit in response to operation information from the operating members 18 on the remote controller 16 or the operating members 13 in the analog broadcast receiver unit 20.

In the digital broadcast receiver unit 21, on the other hand, digital television broadcast data received and then frequency converted is applied to an input terminal 31. The digital television broadcast data applied to the input terminal 31 is sent to a tuner 32 where television data on a desired channel is extracted.

The television data extracted in the tuner 23 is applied to a demodulator 33 where it is subjected to required processes, such as demodulation, error correction, etc. In a usual case, the television data is then fed to a descramble unit 34 where it is descrambled on the basis of the descramble key information recorded on the IC card 14 plugged into the card slot 15.

The television data descrambled in the descramble unit 34 is applied to a demultiplexer 35 where it is separated into audio data and picture data and then applied to an MPEG (Moving Picture Image Coding Experts Group)-2 decoder 36 where they are expanded.

The audio data thus expanded in the MPEG-2 decoder 36 is conducted through the selector 26 to the loudspeaker 27, whereby audio is reproduced. The picture data expanded in the MPEG-2 decoder 36 is fed through the selector 26 to the CRT 29, whereby a picture is reproduced in the screen display unit 12.

The digital broadcast receiver unit 21 can receive and reproduce digital television broadcasts as a result of a digital television broadcast receiving microcomputer 37 controlling each unit in response to operation information from the operating members 18 on the remote controller 16 or the operating members 13 in the analog broadcast receiver unit 20.

In a state where the IC card 14 is plugged into the card slot 15 of the television broadcast receiver 11, the recorded contract information and descramble key information on it are fed into the microcomputer 37 via a card interface 38.

The microcomputer 37 then makes a decision of whether a regular viewing contract has been made with the program provider on the basis of the received contract information and, when it is decided that the viewing contract is valid, supplies the received descramble key information to the descramble unit 34, thereby allowing the television data to be descrambled.

The microcomputer 37 in the digital broadcast receiver unit 21 and the microcomputer 30 in the analog broadcast receiver unit 20 are interconnected, thus allowing data transfer therebetween.

The microcomputer 37 in the digital broadcast receiver unit 21 is provided with an interface 39 adapted to increase functions of the receiver (add new functions to the receiver). The function-expansion interface 39, which operates when the IC card 14 having a memory (semiconductor memory) 14a for data storage built in as described previously is plugged into the card slot 15, is provided to increase further the receiver's functions using the IC card 14.

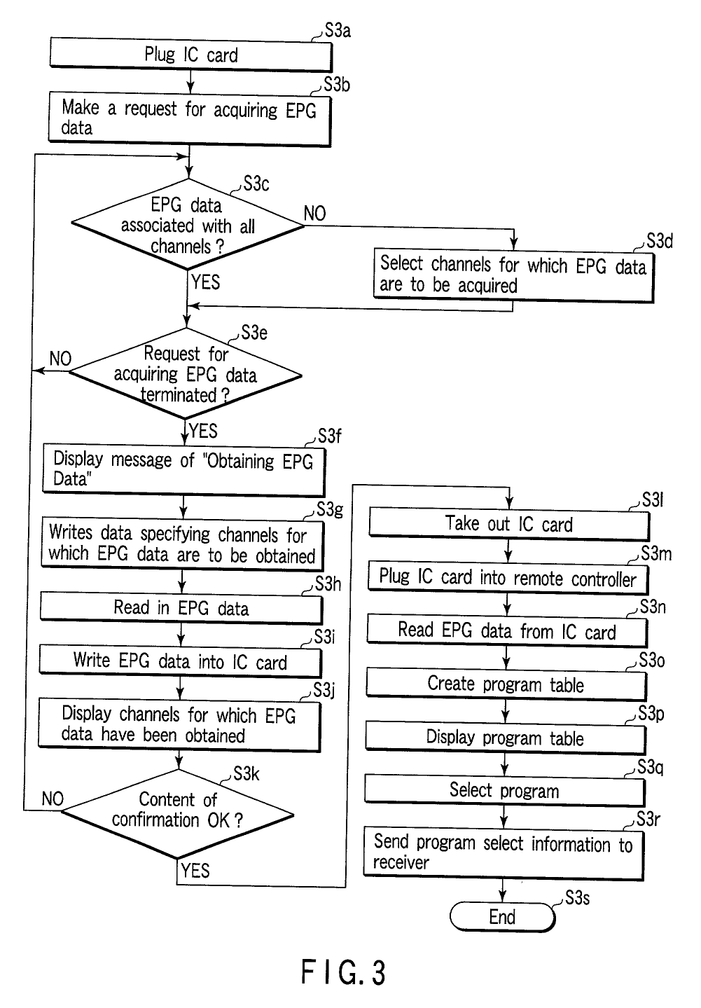

FIG. 3 is a flowchart illustrating a first example of an added function. The first example indicates a case where a viewer plugs the IC card 14 having the built-in semiconductor memory 14a for data storage into the card slot 15 in the television broadcast receiver 11 in step S3a and then operates the operating members 18 or 13 in step S3b to make a request for acquisition of EPG (Electronic Program Guide) data for program selection.

Here, the EPG will be described briefly. In digital broadcast services for television programs, advances in digital compression technology have allowed one network (program provider) to provide over 100 channels of programs. For this reason, it is important to allow viewers to retrieve their favorite program from many programs readily and quickly.

To date, therefore, a technique has been implemented which retrieves a program using an electronic program guide referred to as the EPG. The EPG-based program retrieval means, on the side of the digital broadcast receiver 21, creates a program table with channels and date and time as parameters utilizing EPG data sent attendant on picture and audio information that make up programs and displays the resulting table on the television screen.

After having made a request for acquisition of EPG data in step S3b, the viewer determines whether to acquire EPG data associated with all channels that can be received in step S3c and, when not all channel EPG data are to be acquired, selects channels for which EPG data are to be acquired in step S3d.

After step S3d or when a request for acquisition of all channel EPG data was made (YES) in step S3c, in step S3e the viewer determines whether or not the request for acquisition of EPG data by operation of the operating members 18 (13) has terminated. If not terminated, the process is returned to step S3c.

When the request for acquisition of EPG data has terminated (YES) in step S3e, the microcomputer 37 displays on the screen display unit 12 in the television broadcast receiver 11 a message of “Obtaining EPG Data” in step S3f and then writes data specifying channels for which EPG data are to be obtained into its built-in semiconductor memory (not shown) in step S3g.

The microcomputer 37, in step S3h, reads in EPG data associated with the channels specified by the data written into its built-in semiconductor memory and then, in step S3i, writes the EPG data into the semiconductor memory 14a in the IC card 14 through the card interface 38.

After that, in step S3j the microcomputer 37 displays the channels for which EPG data have been obtained on the screen display unit 12 of the television broadcast receiver 11 to allow the viewer to confirm them. The viewer then decides whether or not the content of confirmation is OK in step S3k. If not OK (NO), the process returns to step S3c.

If the content of confirmation is OK (YES) in step S3k, then the viewer takes the IC card 14 out of the card slot 15 of the television broadcast receiver 11 in step S3l and then plugs it into the card slot 19 of the remote controller 16 in step S3m.

The remote controller 16 reads the EPG data written in the semiconductor memory 14a in the IC card 14 in step S3n, creates a program table by decoding the EPG data in step S3o, and displays the program table on the liquid crystal display unit 17 in step S3p.

The viewer thus selects a program on the program table displayed on the liquid crystal display unit 17 in step S3q and then operates the operating members 18 on the remote controller 16 to send information about the selected program to the television broadcast receiver 11 in step S3r. The procedure then comes to an end (step S3s).

That is, in the first example described above, first, the IC card 14 is loaded into the television broadcast receiver 11 so that EPG data obtained by the television broadcast receiver 11 can be written into the data storage semiconductor memory 14a built in the card 14.

After that, the IC card 14 is taken out of the television broadcast receiver 11 and then plugged into the remote controller 16 so that a program table is created in the remote controller on the basis of the EPG data recorded on the IC card 15 and displayed on the liquid crystal display unit 17.

Finally, the viewer selects a program on the program table displayed on the liquid crystal display unit 17 of the remote controller 16 and then operates the operating members 18 on the remote controller 16 to send information about the selected program to the television broadcast receiver 11, thereby allowing a program to be selected.

In summary, since the data storage semiconductor memory 14a is built into the IC card 14 recorded with contract information and descramble key information and the function-expansion interface 39 is incorporated into the microcomputer 37 and controlled so that, when the IC card 14 is plugged into the card slot 15, EPG data can be written into the semiconductor memory 14a in the IC card 14, the receiver's functions can be increased without damaging the function of the conditional access system and with simple arrangement.

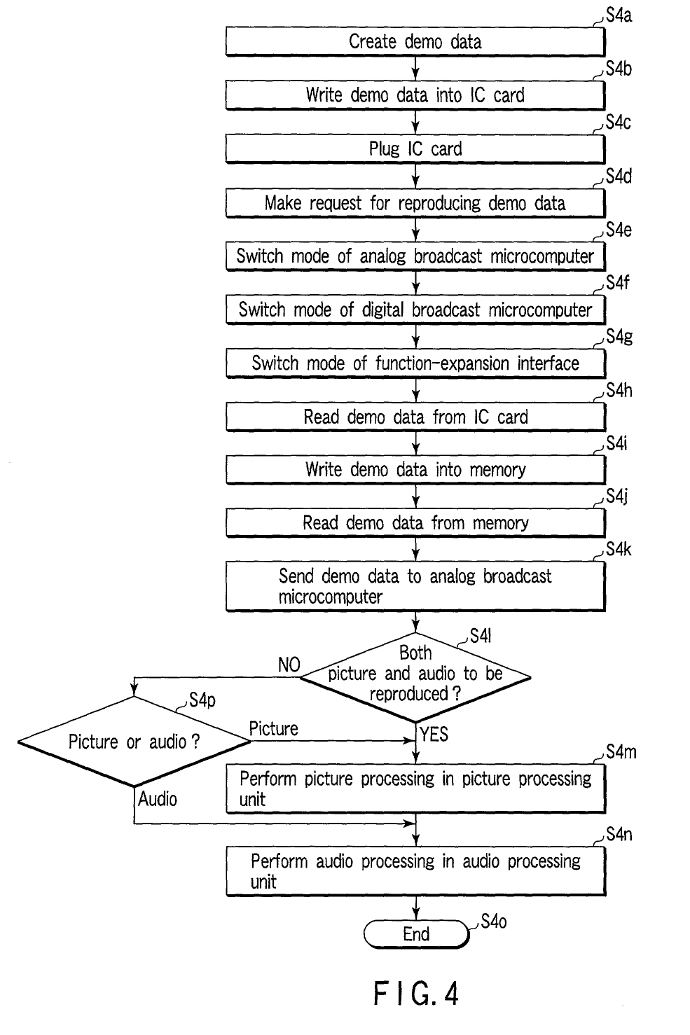

Next, FIG. 4 is a flowchart illustrating a second example of an added function. The second example indicates a case where the viewer can create predetermined demonstration data in step S4a and write the resulting demonstration data into the semiconductor memory 14a in the IC card 14 in step S4b.

In this case, the viewer plugs the IC card 14 recorded with the demonstration data into the card slot 15 of the television broadcast receiver 11 in step S4c and then operates the operating members 18 or 13 to make a request to reproduce the demonstration data in step S4d.

As a result, the microcomputer 30 in the analog broadcast receiver 20 is switched in step S4e into a mode in which the demonstration data recorded on the IC card 14 is reproduced.

After that, the microcomputer 37 and its function-expansion interface 39 in the digital broadcast receiver 21 are switched sequentially into the demonstration data reproducing mode in steps S4f and S4g.

The microcomputer 37 reads the demonstration data from the IC card 14 via the card interface 38 in step S4h and then writes the read demonstration data into the built-in semiconductor memory in step S4i.

After that, the microcomputer 37 reads the demonstration data from the semiconductor memory in step S4j and then transfers the read data to the microcomputer 30 in the analog broadcast receiver 20 in step S4k.

The microcomputer 30 then makes a decision of whether or not the request has been made for reproducing both picture and audio data in step S4l. If the request has been made for reproducing both of them (YES), then the microcomputer first causes the picture processing unit 28 to perform processing on picture data in the demonstration data in step S4m and next causes the audio processing unit 25 to perform processing on audio data in the demonstration data in step S4n. The procedure then ends (step S4o).

If the request has not been made for reproducing both of the picture and the audio data (NO) in step S4l, then the microcomputer 30 determines which of picture reproduction and audio reproduction the request has been made for in step S4p. If the request has been made for audio reproduction, the procedure goes to step S4n. If, on the other hand, the request has been made for picture reproduction, the procedure goes to step S4m. The procedure then ends (step S4o).

That is, in the second example described above, the demonstration data created by the viewer is written into the semiconductor memory 14a in the IC card 14 and the IC card is plugged into the television broadcast receiver 11 to reproduce the demonstration data.

In this case as well, since the function-expansion interface 39 is installed in the microcomputer 37 and controlled so that the demonstration data can be reproduced with the IC card 14 recorded with the demonstration data plugged into the card slot 15, the receiver's functions can be expanded without damaging the function of the conditional access system and with simple arrangement.

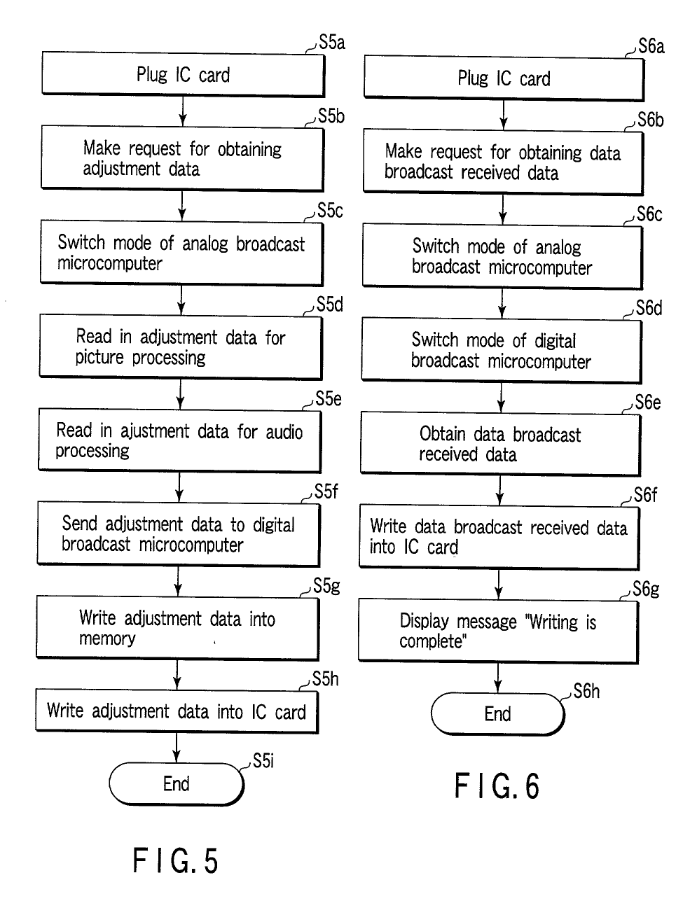

Next, FIG. 5 is a flowchart illustrating a third example of an added function. The third example indicates a case where the IC card 14 is plugged into the card slot 15 of the television broadcast receiver 11 in step S5a and then a request is made for acquiring adjustment data for each unit in the receiver by operating the operating members 18 or 13 in step S5b.

The microcomputer 30 in the analog broadcast receiver unit 20 is then switched into a mode to acquire adjustment data for each unit in the television broadcast receiver 11. As a result, the microcomputer 30 reads in adjustment data for the picture processing unit 28 in step S5d and then adjustment data for the audio processing unit 25 in step S5e.

After that, the microcomputer 30 sends the read adjustment data to the microcomputer 37 in the digital broadcast receiver unit 21 in step S5f, writes the data into the semiconductor memory in the microcomputer 37 in step S5g, and reads the adjustment data from the semiconductor memory and writes it into the semiconductor memory 14a in the IC card 14 in step S5h. The process then ends (step S5i).

That is, the above third example is adapted to record the adjustment data for each unit on the IC card 14 loaded into the television broadcast receiver 11. Examples of adjustment data include TV set adjustment data, shipping adjustment data, user adjustment data, and programs for controlling them.

If adjustment data for each unit in the television broadcast receiver 11 can be recorded on the IC card 14 as described above, then loading the IC card into another television broadcast receiver allows that receiver to be adjusted readily as is the case with the receiver 11.

In this case as well, since the function-expansion interface 39 is installed in the microcomputer 37 and controlled so that, in a state where the IC card 14 is plugged into the card slot 15, the adjustment data for each unit in the television broadcast receiver 11 can be recorded on its semiconductor memory 14, the expansion of the receiver's functions can be effected without damaging the function of the conditional access system and with simple arrangement.

Next, FIG. 6 is a flowchart illustrating a fourth example of an added function. The fourth example indicates a case where the IC card 14 is plugged into the card slot 15 of the television broadcast receiver 11 in step S6a and then a request is made for obtaining data broadcast received data by operating the operating members 18 or 13 in step S6b.

The data broadcast received data, which is data that is output from the demultiplexer 35 in the digital broadcast receiver unit 21 to the microcomputer 37, includes common information ECM (Entitlement Control Message) for the conditional access CA, individual information EMM (Entitlement Management Message) for the conditional access CA, and information PSI (Program Specific Information) necessary for channel selection.

That is, when the viewer makes a request for obtaining data broadcast received data in step S6b, the microcomputer 30 in the analog broadcast receiver unit 20 is switched in step S6c into the mode in which the data broadcast received data is obtained and then the microcomputer 37 in the digital broadcast receiver unit 21 is switched in step S6d into the mode in which the data broadcast received data is obtained.

The microcomputer 37 acquires the data broadcast received data output from the demultiplexer 35 in step S6e, writes the acquired data broadcast received data into the semiconductor memory 14a in the IC card 14 in step S6f, and displays a message stating that the writing is complete in step S6g. The procedure then ends (step S6h).

That is, in the above fourth embodiment, the data broadcast received data is recorded on the IC card 14 loaded into the television broadcast receiver 11. Thus, if the data broadcast received data can be recorded on the IC card 14, the recorded data broadcast received data is made available easily by loading the card into another television broadcast receiver.

In this case as well, since the function-expansion interface 39 is installed in the microcomputer 37 and controlled so that, in a state where the IC card 14 is plugged into the card slot 15, the data broadcast received data can be recorded on its semiconductor memory 14, the expansion of the receiver's functions can be effected without damaging the function of the conditional access system and with simple arrangement.

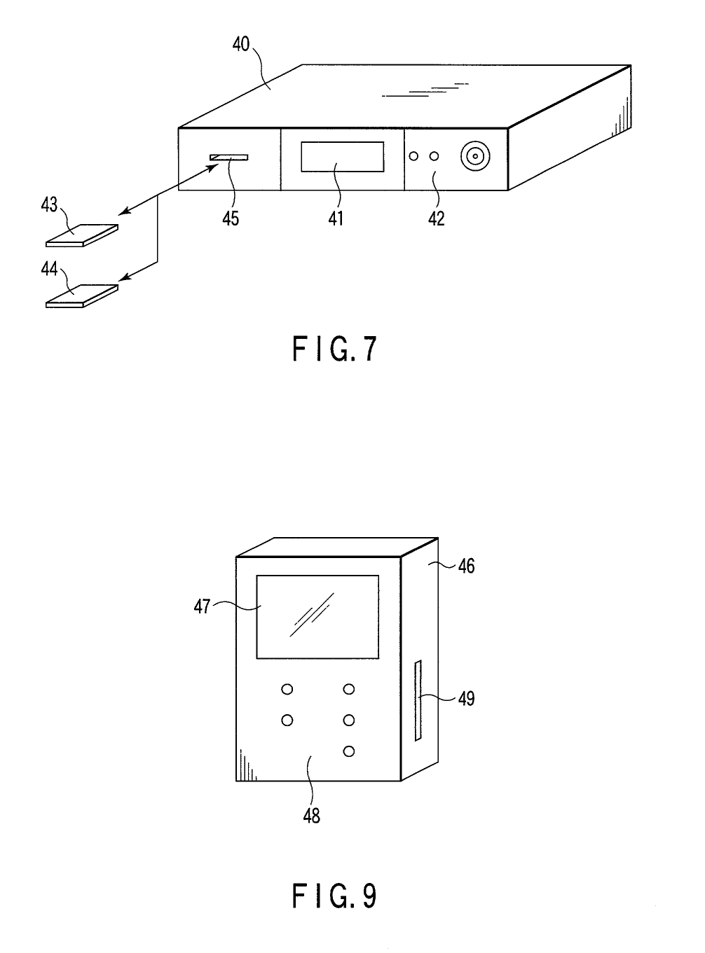

A second embodiment of the present invention will be described next. That is, although the first embodiment has been described in terms of the television broadcast receiver 11 including both the analog broadcast receiver unit 20 and the digital broadcast receiver unit 21, the second embodiment is described in terms of such a so-called digital set-top box 40 as shown in FIG. 7 which is provided only with the digital broadcast receiver unit 21.

The digital set-top box 40 is equipped with a liquid crystal display unit 41, various operating members 42, and a card slot 45 into which a conventional IC card 43 recorded with contract information and descramble key information or an IC card 44 with a built-in data storage semiconductor memory not shown can selectively be plugged.

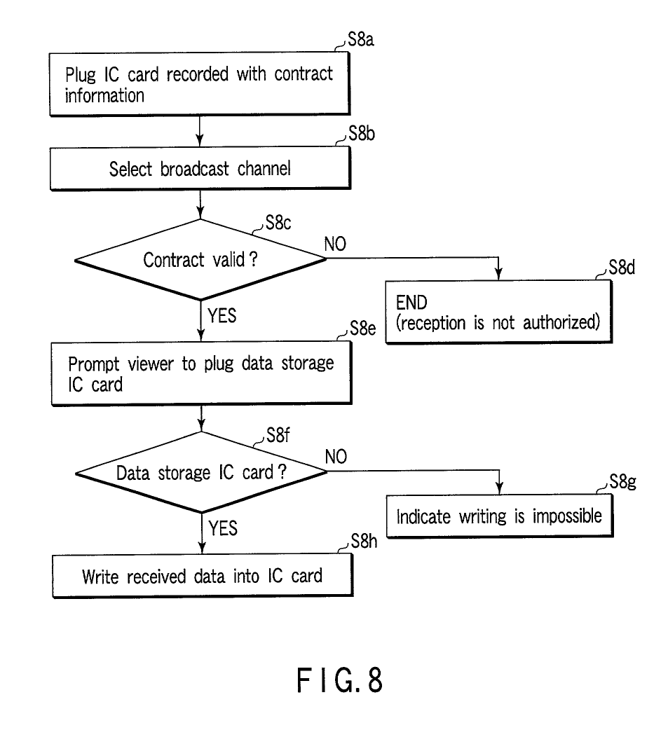

FIG. 8 is a flowchart illustrating an example of an added function in the digital set-top box 40. That is, a viewer plugs the IC card 43 recorded with contract information and descramble key information into the card slot 45 in the digital set-top box 40 in step S8a and then operates the operating members 42 in step S8b to select a desired broadcast channel.

The digital set-top box 40 then reads the contract information recorded on the IC card 43 to make a decision of whether or not the contract is valid for the broadcast channel selected by the viewer in step S8c. If not valid (NO), the procedure ends in step S8d because the reception is not authorized.

If, on the other hand, the decision in step S8c is that the contract is valid (YES), then the digital set-top box 40 prompts, though the liquid crystal display unit 41, the viewer to take the IC card 43 out of the car slot 45 and plug the data storage IC card 44 instead into the card slot 45 in step S8e. This prompt may be performed in an audible manner.

When the viewer removes the IC card 43 and then plugs the data storage IC card 44 into the card slot 45 on the basis of that prompt, the digital set-top box 40 makes a decision of whether or not the plugged IC card is one for data storage in step S8f.

If the plugged IC card is not one for data storage (NO), then the digital set-top box 40 indicates to the viewer through the liquid crystal display unit 41 in step S8g that the plugged IC card cannot be written into.

If, on the other hand, it is decided in step S8f that the plugged IC card is one for data storage (YES), then the digital set-top box 40 performs descramble processing on the received data on the previously selected broadcast channel on the basis of the descramble key information read from the previously plugged IC card 43 and then writes the received data into the IC card 44 in step S8h.

In step S8e, instead of prompting the viewer to plug the IC card 44 in place of the IC card 43, the digital set-top box 40 may eject forcedly the IC card 43 from the card slot 45 and cause the liquid crystal display unit 41 to prompt the viewer to load the IC card 44.

The IC card 44 thus recorded with the received data is plugged into such a small portable terminal 46 as shown in FIG. 9, which is equipped with a liquid crystal display unit 47, various operating members 48, and a card slot 49 into which the data storage IC card 44 can be plugged.

The portable terminal 46, when the IC card 44 is plugged into its card slot 49 and a request for reproduction is made through the operating members 48, reads the received data from the IC card 44, performs decode processing on it, displays pictures on the liquid crystal display unit 47, and reproduces audio through a loudspeaker not shown.

In the second embodiment, the IC card 43 recorded with contract information and descramble key information is first plugged into the digital set-top box 40 and then a decision is made as to whether or not the contract is valid. If the contract is valid, then the data storage IC card 44 is loaded in place of the IC card 43 to thereby record the received data on the IC card 44.

After that, the IC card 44 recorded with the received data is taken out of the digital set-top box 40 and then plugged into the portable terminal 46 designed to allow the received data to be reproduced, thereby allowing the viewer to enjoy broadcast programs in any place where no digital set-top box is installed as in the outdoor.

In this case as well, since the function-expansion interface 39 is installed in the microcomputer 37 in the digital broadcast receiver unit 21 and controlled so that a decision is made on contract information with the IC card 43 plugged into the card slot 45 and then received data can be recorded on the IC card 44 plugged into the card slot 45, the expansion of the receiver's functions can be effected without damaging the function of the conditional access system and with simple arrangement.

In addition, in the second embodiment, although the data storage IC card 44 with a built-in semiconductor memory is used to record received data, this is not restrictive. For example, a card-like adapter that is connected to a recording/reproducing apparatus using tape or a disk as a recording medium may be plugged into the card slot 45 in the digital set-top box 40 so as to record received data on the recording medium.

The invention is not limited to the above embodiments but may be practiced or embodied in still other ways without departing the scope and sprit thereof.

According to the present invention, as described above in detail, a very good digital broadcast receiver can be provided which is simple in construction which becomes well suited for practical use for viewers by making organic improvements on an IC card and its associated control system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital broadcast receiver which receives digital broadcast data and includes control means that reproduces the digital broadcast data on the basis of contract information recorded on a memory card plugged into a card slot, wherein a memory for data storage is built into the memory card, and an interface means for being added to the control means which obtains program selecting data contained in the received digital broadcast data and writes the received digital broadcast data into the memory in the memory card plugged into the card slot.

2. The digital broadcast receiver according to claim 1, wherein the interface means obtains adjustment data for each unit in the digital broadcast receiver and writes the received digital broadcast data into the memory in the memory card plugged into the card slot.

3. The digital broadcast receiver according to claim 1, wherein the interface means obtains data broadcast received data contained in the received digital broadcast data and writes the received digital broadcast data into the memory in the memory card plugged into the card slot.

4. The digital broadcast receiver according to claim 1, wherein a remote control means for operating the digital broadcast receiver by remote control is equipped with operating members, a display unit, and a card slot, and, when the memory card is plugged into the card slot, reproduces data recorded in the memory for control of display and operation in the display unit and the operating members.

5. A digital broadcast receiver which receives digital broadcast data and includes control section that reproduces the digital broadcast data on the basis of contract information recorded on a memory card plugged into a card slot, wherein a memory for data storage is built into the memory card, and an interface section is added to the control section which obtains program selecting data contained in the received digital broadcast data and writes the received digital broadcast data into the memory in the memory card plugged into the card slot.

6. A digital broadcast receiver which receives digital broadcast data and performs reproduction processing on the broadcast data on the basis of contract information recorded on a first memory card plugged into a card slot, comprising:
a second memory card which has a built-in memory for data storage and can be plugged into the card slot in place of the first memory card;
first means for reading the contract information from the first memory card plugged into the card slot to make a decision of whether or not the reproduction of the received digital broadcast data is authorized;
second means for, when it is decided by the first means that the reproduction of the digital broadcast data is authorized, prompting a viewer to plug the second memory card into the card slot in place of the first memory card; and
third means for performing a control operation so that data obtained by reproducing the received digital broadcast data is written into the memory in the second memory card plugged into the card slot in response to the second means.

7. A digital broadcast receiver which receives digital broadcast data and performs reproduction processing on the broadcast data on the basis of contract information recorded on a first memory card plugged into a card slot, comprising:
a second memory card which has a built-in memory for data storage and can be plugged into the card slot in place of the first memory card;
first section read the contract information from the first memory card plugged into the card slot to make a decision of whether or not the reproduction of the received digital broadcast data is authorized;
second section, when it is decided by the first section that the reproduction of the digital broadcast data is authorized, prompt a viewer to plug the second memory card into the card slot in place of the first memory card; and
third section perform a control operation so that data obtained by reproducing the received digital broadcast data is written into the memory in the second memory card plugged into the card slot in response to the second section.

8. A digital broadcast receiver which receives digital broadcast data and performs reproduction processing on the digital broadcast data on the basis of contract information recorded on a first memory card loaded, comprising:
a second memory card which has a built-in memory for data storage and can be loaded in place of the first memory card;
first means for reading the contract information from the first memory card loaded to make a decision of whether or not the reproduction of the received digital broadcast data is authorized;
second means for, when it is decided by the first means that the reproduction of the digital broadcast data is authorized, prompting a viewer to load the second memory card; and
third means for performing a control operation so that data obtained by reproducing the received digital broadcast data is written into the memory in the second memory card loaded in response to the second means.

9. A digital broadcast receiver which receives digital broadcast data and performs reproduction processing on the digital broadcast data on the basis of contract information recorded on a first memory card loaded, comprising:
a second memory card which has a built-in memory for data storage and can be loaded in place of the first memory card;
first section read the contract information from the first memory card loaded to make a decision of whether or not the reproduction of the received digital broadcast data is authorized;
second section, when it is decided by the first section that the reproduction of the digital broadcast data is authorized, prompt a viewer to load the second memory card; and
third section perform a control operation so that data obtained by reproducing the received digital broadcast data is written into the memory in the second memory card loaded in response to the second section.

10. The digital broadcast receiver according to claim 6 or 8, wherein the second means includes means for ejecting forcedly the first memory card loaded.

11. A digital broadcast receiver which receives digital broadcast data and includes control means that reproduces the digital broadcast data on the basis of contract information recorded on a memory card plugged into a card slot and which is adapted to be remotely-controlled by a remote controller, wherein the memory card has a memory for data storage built in, the control means includes interface means which obtains program selecting data contained in the received digital broadcast data and writes the received digital broadcast data into the memory in the memory card plugged into the card slot, and the remote controller is equipped with operating members, a display unit, and a card slot and, when the memory card is plugged into its card slot, reproduces the program selecting data recorded on the memory and displays the program selecting data on the display unit, and sends program select information selected on the basis of the display on the display unit to the digital broadcast receiver.

12. A digital broadcast receiver which receives digital broadcast data and includes control section that reproduces the digital broadcast data on the basis of contract information recorded on a memory card plugged into a card slot and which is adapted to be remotely-controlled by a remote controller, wherein the memory card has a memory for data storage built in, the control section includes interface section which obtains program selecting data contained in the received digital broadcast data and writes the received digital broadcast data into the memory in the memory card plugged into the card slot, and the remote controller is equipped with operating members, a display unit, and a card slot and, when the memory card is plugged into its card slot, reproduces the program selecting data recorded on the memory and displays the program selecting data on the display unit, and sends program select information selected on the basis of the display on the display unit to the digital broadcast receiver.

13. A method of controlling a digital broadcast receiver, adapted to be remotely controlled by means of a remote controller, so that received digital broadcast data is reproduced on the basis of contract information recorded on a memory card plugged into a card slot, comprising:
a recording step of obtaining program selecting data contained in the received digital broadcast data and writing the program selecting data into a memory for data storage built in the memory card plugged into the card slot;
a display step of plugging the memory card having its memory recorded with the program selecting data into a card slot provided in the remote controller, reproducing the program selecting data recorded on the memory card and displaying the program selecting data on a display unit provided in the remote controller; and
a transmit step of sending program select information selected from the displayed contents on the display unit of the remote controller on the basis of an operation of the operating members of the remote controller to the digital broadcast receiver.

14. A digital broadcast receiver which receives digital broadcast data and includes control means that reproduces the digital broadcast data on the basis of contract information recorded on a first memory card and which can be remotely-controlled by a remote controller, wherein
a second memory card is provided which has a built-in memory for data storage and can be plugged into the digital broadcast receiver,
the control means includes interface means which obtains program selecting data contained in the received digital broadcast data and writes the received digital broadcast data into the memory in the memory card plugged, and
the remote controller is equipped with operating members, a display unit, and a card slot and, when the second memory card is plugged into its card slot, reproduces the program selecting data recorded on the memory and displays the program selecting data on the display unit, and sends program select information selected on the basis of the display on the display unit to the digital broadcast receiver.

15. A digital broadcast receiver which receives digital broadcast data and includes control section that reproduces the digital broadcast data on the basis of contract information recorded on a first memory card and which can be remotely-controlled by a remote controller, wherein
a second memory card is provided which has a built-in memory for data storage and can be plugged into the digital broadcast receiver,
the control section includes interface section which obtains program selecting data contained in the received digital broadcast data and writes the received digital broadcast data into the memory in the memory card plugged, and
the remote controller is equipped with operating members, a display unit, and a card slot and, when the second memory card is plugged into its card slot, reproduces the program selecting data recorded on the memory and displays the program selecting data on the display unit, and sends program select information selected on the basis of the display on the display unit to the digital broadcast receiver.

16. A remote controller for operating a digital broadcast receiver by remote control which receives digital broadcast data and performs reproduction processing on the digital broadcast data on the basis of contract information recorded on a memory card plugged into a card slot, wherein
the memory card has a memory for data storage built in and, when plugged into the card slot, allows program selecting data contained in the received digital broadcast data to be written into the memory, and
the remote controller has operating members, a display unit, and a card slot and, when the memory card is plugged into its card slot, reproduces the program selecting data recorded on the memory and displays the program selecting data on the display unit, and sends program select information selected on the basis of the display on the display unit to the digital broadcast receiver.

17. A method of controlling a digital broadcast receiver by means of a remote controller so as to reproduce received digital broadcast data on the basis of contract information recorded on a memory card plugged into a card slot comprising:
a display step of, when the memory card having program selecting data contained in the received digital broadcast data written into its built-in memory for data storage is plugged into a card slot of the remote controller, reproducing the program selecting data recorded on the memory card, and displaying the program selecting data on a display unit provided in the remote controller; and
a transmit step of sending program select information selected from the displayed contents on the display unit of the remote controller on the basis of an operation of the operating members of the remote controller to the digital broadcast receiver.

18. A digital broadcast receiver which receives digital broadcast data and performs reproduction processing on the digital broadcast data comprising:
a card slot into which a memory card having its built-in memory written with predetermined demonstration data can be plugged; and
a reproducer for, when the memory card is plugged into the card slot and a request is made to reproduce the demonstration data, to read the demonstration data from the memory in the memory card and to perform reproduction processing on the demonstration data.

19. A digital broadcast receiver which receives digital broadcast data and performs reproduction processing on the digital broadcast data comprising:
a card slot into which a memory card having its built-in memory written with adjustment data for each unit can be plugged; and
a controller, when the memory card is plugged into the card slot, to read the adjustment data from the memory in the memory card and to adjust each unit on the basis of the read adjustment data.

20. A remote controller which operates a remote controller so as to reproduce received digital broadcast data on the basis of contract information recorded on a memory card wherein it is equipped with operating members, a display unit, and a card slot and has functions of, when the memory card having program selecting data contained in the received digital broadcast data written into its built-in memory for data storage is plugged into the card slot, reproducing the program selecting data recorded on the memory of the memory card, displaying the program selecting data on the display unit, and sending program select information selected from the displayed contents on the display unit on the basis of an operation of the operating members to the digital broadcast receiver.
